(19) United States
(12) Patent Application Publication
(10) Pub. No.: US 2004/0034688 A1
(43) Pub. Date: Feb. 19, 2004

(54) Transfer and management of linked objects over networks

(75) Inventor: Max Dunn, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Xythos Software, Inc., San Francisco, CA

(21) Appl. No.: 10/222,756

(22) Filed: Aug. 16, 2002

(51) Int. Cl. G06F 15/16

(52) U.S. Cl. 709/206

(57) ABSTRACT

A mater copy of an attachment, such as a document attached to an email message, is maintained at a server. When users desire to modify, forward, resend, etc., the attachment, links to the attachment are provided with an email message. Version and access controls are maintained by the server and specialized client software working with application programs and with the email system. A preferred embodiment of the invention uses a hypertext link to open a web page that allows controlled access to the attachment. A user interface is provided to allow a user to designate how an attachment is handled. The creator of an attachment can set access rights and restrictions for other users and recipients. A status monitor is provided to view conditions and operations related to an attachment. An access interface is provided to allow a recipient of a link to a document to view and otherwise obtain the document and to perform operations on the document.

### BACKGROUND OF THE INVENTION

This invention relates in general to transfer of information over computer networks and more specifically to transfer and management of email attachments.

Email has become prevalent as a means of communication. Often, an object such as a text document, image, audio file, spreadsheet, etc., is included as an “attachment” to an email message. The use of attachments allows a sender to not only provide additional objects to a user, or group of users, via email but also to provide comments about the attachment in the email with which the object is associated, or attached. The recipient of the attachment can, in turn, modify the attachment and re-send the attachment to the originator.

Email systems provide users with many built-in features. For example, users can easily forward email and associated attachments. Address books are maintained so that prior email contacts can be easily recalled and contacted. Email can be forwarded with additional annotations (i.e., email messages). Email search facilities include content searching of email headers, senders, recipients, message text and even attachments. Thus, an email system is useful for transferring, discussing, collaborating, developing, etc., data in any form that is suitable for an email attachment.

However, the use of email attachments with traditional email systems has shortcomings. For example, in a group or “team” working environment where several, or many, users exchange objects with email, traditional email systems result in multiple copies of exchanged objects throughout the email system. This is especially true when users modify the objects and re-distribute the updated objects to other team members. FIGS. 1A-D illustrate object proliferation and problems with object version control in traditional email systems.

FIG. 1A shows selected computer systems in a prior art email system after creation of an email and attachment, and prior to sending the email and attachment.

In FIG. 1A, client1, server and client2 computers are part of a traditional email system. As such, they execute appropriate email client and server software processes, as shown. In the Figures, processes are enclosed in rounded boxes while information that is transferred, created or stored is shown in right-angle cornered boxes. Client1 includes a word processing process, WP, that a human user operates to create a document, Doc1. A client email process executing on the client 1 computer is used to create an email message, email 1. Doc1 is attached to the email message by “embedding” the attachment into, or with, the email message. Typically attaching occurs at the time of composing the email message and is done within the email program, i.e., by using the client email process executing on the user's computer. Note that this results in two copies of Doc1 on the originating user's computer.

FIG. 1B shows the state of the email system after email1 and its attachment, doc, have been sent to the target destination computer system, client2, via the server computer. As shown in FIG. 1B, the email message, email1, has been transferred by the server and email server process to client2. Since the attachment is embedded within the email message, the server merely handles the email and attachment as a single unit, stores the combination and then passes it through to client2. Typically, email messages are small and attachments are relatively large so that frequent, or replicated, email exchanges of the type shown in FIG. 1B can have the unwanted effect of greatly increasing traffic through a server and the storage space needed on a server. Note that some email systems will delete the email on the server after it is retrieved by the recipient.

Email1 with embedded doc1 is received at client2. The end result of sending email1, with its attachment doc, to client2 via the server results in two local copies of doc1 on the originating computer, client1; and a copy of email1 and doc1 on the server and client 2, the target, or recipient, computer. Note that the situation at the server and client2 is replicated for each of potentially many email recipients (not shown).

FIG. 1C illustrates the status of the exemplary email system after a user at client2 makes modifications to doc1 using a word processor. Usually, a user will copy the embedded attachment to local storage, such as to a hard disk in client2's computer system. The word processor is used to retrieve the local copy of doc1 and edit the copy to produce a second version of the document, called “doc1v2”. Now client2 has two local copies of doc1 and also a local copy of doc1v2.

FIG. 1D illustrates a common operation for teams of email users. That is, modifying and then distributing a modified document to the other team members, including the originating author. In FIG. 1D, a user at client2 composes an email message, email2, and embeds doc1v2 into email2. The user then sends email2 and doc1v2 back to client1. As before, this results in copies of the email and its associated attachment at the sending and receiving computer systems and at the server. Client1 may then make a local copy of the attachment for further modification, personal storage, etc. Naturally, any number of team members can be copied with email2 and the proliferation of copies and versions can multiply.

Note that the sequence of events illustrated in FIGS. 1A-D results in multiple copies of documents throughout the email system. As the number of transfers and modifications increases, so do the number of versions and redundant copies. One problem with this approach is that a user at client 1 may be modifying the version of doc1 at client1 at the same time as a user at client2 is making modifications to client2's local copy of doc1. Resolving these concurrent changes can be very difficult. Moreover, each user is free to send out their independently-modified versions to any number of other users without the knowledge of other users, who may have made, or who may be making, updates to the document.

Other problems can arise in the traditional approach. Different users may not check their respective email “in” boxes often and so may fail to notice that there is an updated form of a document or other attachment. Old email messages having invalid, or outdated, objects can be proliferated to cause much confusion in the team. Moreover, the limited, or lack of, document and versioning control in email systems prevents administrators from granting access rights and providing object control and management, such as versioning, publishing, etc. Finally, the large size of attachments (especially with image information) can consume bandwidth and storage resources in computer systems and in the network.

Other problems or undesirable effects can exist in prior art systems due to proliferation of multiple copies of email attachments, lack of attachment management options, or other causes. Thus, it is desirable to provide a system that alleviates one or more shortcomings in the prior art.

### SUMMARY OF THE INVENTION

The present invention maintains a single copy, or master copy, of a document or other attachment to an email message. The master copy is typically stored on an Internet File Management server that provides access rights, and versioning. Modification and linking to the master copy can be controlled and coordinated.

One feature of the invention is that a local copy of a document is not kept on client computer systems (unless the user desires a backup copy). Rather, the document is kept at the server location. This is true even when a document is newly-created. When a created document is transferred to other users by email, a link to the document (residing on the server) is provided with the email. A preferred embodiment of the invention uses a hypertext link to open a web page that allows controlled access to the attachment.

For example, where the attachment is a document a recipient of email can click on an embedded link to open a web page that provides for further operations. Operations can include opening the attachment read-only in the web browser, opening the attachment read-write in the native application that was used to prepare the attachment, opening a previous version of the attachment, checking out the attachment, and other operations.

A user interface is provided to allow a user to designate how an attachment is handled. The creator of an attachment can set access rights and restrictions for other users and recipients. A status monitor is provided to view conditions and operations related to an attachment. An access interface is provided to allow a recipient of a link to a document to view and otherwise obtain the document and to perform operations on the document.

In one embodiment the invention provides a method for transferring an email attachment from a first processing system to a second processing system via an intermediary system, the method comprising accepting signals from a user input control coupled to the first processing system to create an email message; accepting signals from a user input control coupled to the first processing system to designate an attachment to the email message; transferring at least one copy of the email message to other computer systems; storing a single copy of the attachment in the intermediary system; and ensuring that each copy of the email message includes a link to the single copy of the attachment stored in the intermediary system.

In another embodiment the invention provides a method for creating linked information on a first processing system, the method comprising accepting signals from a user input control coupled to the first processing system to create a primary object; accepting signals from a user input control coupled to the first processing system to create an attachment object; receiving a signal from a user input control to designate the attachment object as a linked object; and in response to the step of receiving, embedding a pointer associated with the primary object in the primary object.

### BRIEF DESCRIPTION OF THE DRAWINGS

FIG. 1A is a first illustration of proliferation of attached objects in a prior art email system;

FIG. 1B is a second illustration of proliferation of attached objects in a prior art email system;

FIG. 1C is a third illustration of proliferation of attached objects in a prior art email system;

FIG. 1D is a fourth illustration of proliferation of attached objects in a prior art email system;

FIG. 2A is a first illustration of handling of email attachments according to the present invention;

FIG. 2B is a second illustration of handling of email attachments according to the present invention;

FIG. 2C is a third illustration of handling of email attachments according to the present invention;

FIG. 2D is a fourth illustration of handling of email attachments according to the present invention;

FIG. 2E shows linking to older versions of attachments;

FIG. 3A shows a first dialogue box that appears when a user is prompted to designate a file;

FIG. 3B shows a status monitor;

FIG. 3C shows an options dialog box;

FIG. 4A shows a text and link inserted into an email; and

FIG. 4B shows a controller web page.

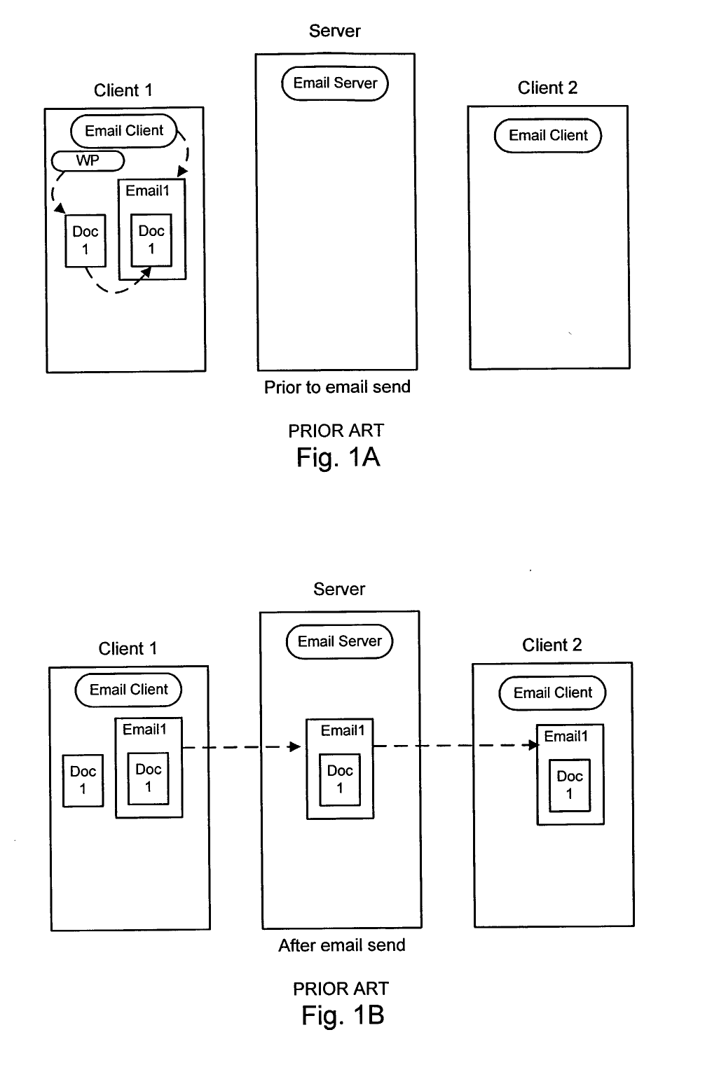

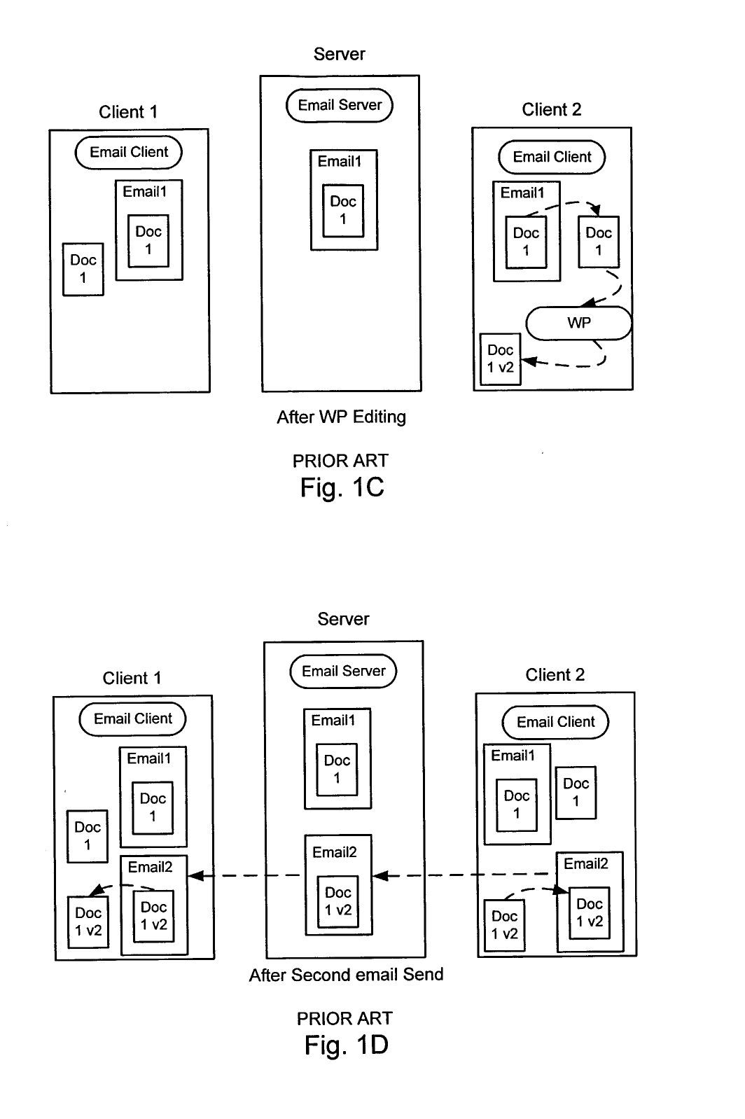

### DETAILED DESCRIPTION OF THE PREFERRED EMBODIMENTS

A preferred embodiment of the invention is designed to facilitate improved transfer and management of email attachments, such as documents, images, audio, spreadsheet, drawings, or other objects or information. However, it should be apparent that aspects of the invention can be used in systems other than email systems. For example, instant messaging, sending of web pages, static web pages, designation of transfers from within application programs, or any program or system that transfers information or that can embed links can be suitable for use with the present invention.

The invention is applicable to any system that allows a user to associate, or link, a secondary information object with a primary information object such that the transfer of the primary object also allows a target recipient of the primary object to access the secondary object. In some systems the use of the primary object may not be necessary, as where, for example, a word processing program, spreadsheet, computer-assisted drawing (CAD) program, etc., provides for sending an information object directly from within the application program.

Features of the present invention, referred to as “Intellittach,” are to be included in a product, or suite of products, manufactured and distributed by Xythos, Inc., of San Francisco, Calif. First, a description of the system and internal storing, transferring and linking is described. Next, details of a user interface are presented.

System

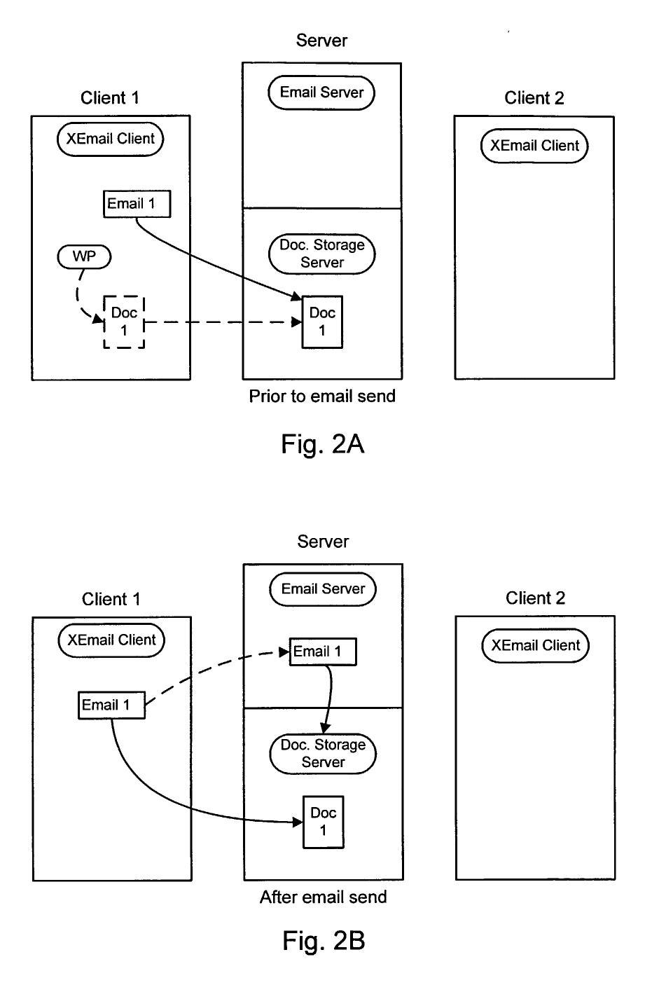

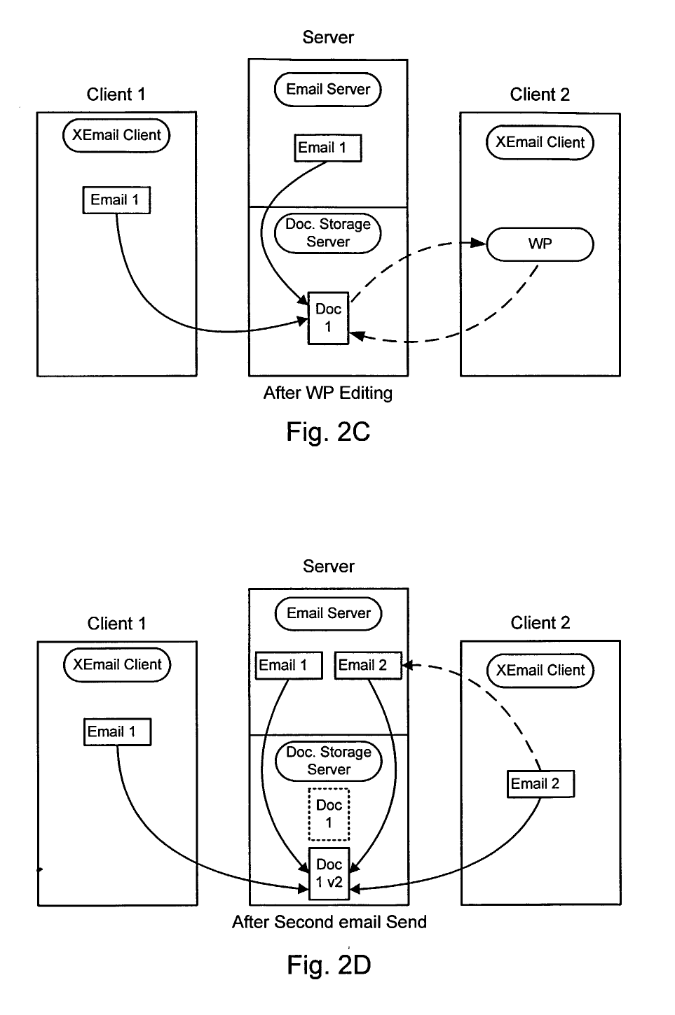

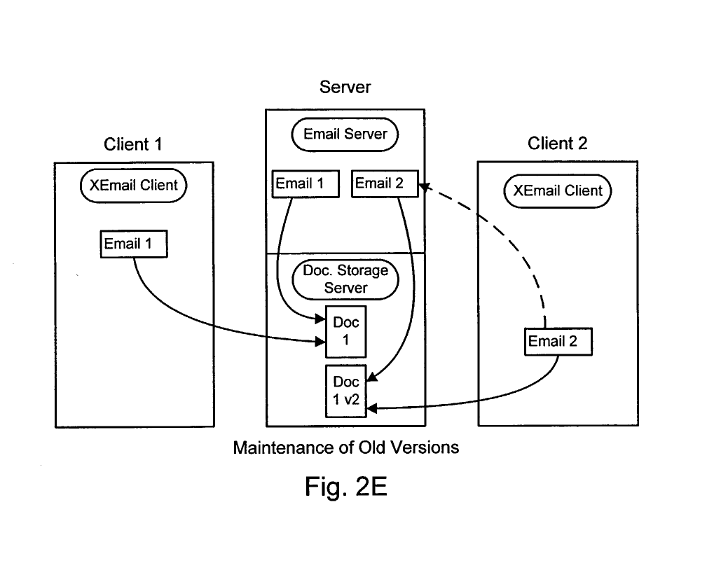

FIG. 2A shows a first illustration of a state of an email system according to the present invention. Similar to the prior art, client1, server and client2 computers execute email processes. However, these processes handle email attachments in modified ways and are designated as “Xemail client” and “document storage server”. Note that these processes can have many of the same functions of traditional email systems and can also be provided with one or more features of the present invention, as desired.

In a preferred embodiment, the document storage server executes on a different physical server than the email server process. Other embodiments can use any configuration of hardware and software to implement the server, client and other functionality described herein in any combination of logical servers and physical server.

In FIG. 2A, a user at client1 creates a document (or other information object) by using an application such as a word processing program. The user then creates an email message, email1, by using the Xemail client process on the client1 computer system. Note that although the examples discussed herein are primarily directed to a client-server architecture system, any type of design is possible. For example, peer-to-peer arrangements, closed networks, etc., can be used.

The user designates Doc1 as an attachment to be associated with email1. Unlike the prior art, a copy of the attachment is not maintained locally to client1 (although the user can choose to keep one, if desired). Instead, the attachment object is transferred to the server computer and a link, or other pointer or association, is created from email1 to Doc1. Note that other embodiments may allow local copies of Doc1 but these copies are never linked to by any of the email messages.

The association of Doc1 to email1 is indicated in the diagrams with a solid arrow line. In general, but not necessarily exclusively, data associations are shown in the Figures with solid arrow lines while the transfer, creation or movement or other manipulation of data is shown with a dashed line.

FIG. 2B shows the state of the system after transfer of email1 from client1 to client2. In FIG. 2B, a copy of email1 now resides on client2 with a link to Doc1, which is stored on the server.

In FIG. 2C, a user at client2 modifies Doc1 using an application program such as a word processor. The word processor retrieves Doc1 and returns a modified version to the server so that the server can manage the different versions as desired. Various approaches to version control are described in more detail, below.

The application program acts to modify the single copy of Doc1 maintained by the server computer. Although a local copy of Doc1 must be obtained at client2, at some point, such as upon saving a modified version of the document, eventually the server's copy of Doc1 is updated to a newer version. All email messages are linked to the server's copy of Doc1.

FIG. 2D shows that a new version of Doc1, named “Doc1v2,” has been created and stored in the server. A user at client2 can compose a second email message, email2, designate the new version as an attachment to email2, and send email2 to other users in the team, such as sending back to the user at client1.

Note that the embodiment shown in FIG. 2D allows only a single version of a “single copy” of the attachment to exist and be accessed by the various email messages. Prior email messages, such as email1, that referenced an older version of the single copy are updated so that they point to the latest version. Another way to describe this is that only a single copy of the document is maintained so that changes to the document automatically result in prior links pointing to the updated document.

A different embodiment is shown in FIG. 2E. In FIG. 2E, older links from email messages continue to point to their older versions of the documents. The maintenance of these different versions can be handled in different ways. Users who access the older versions can be informed that a newer version exists. Modification of older versions can be restricted, etc.

The present invention can provide several advantages. Copies of attachments can be controlled by a single entity, or process. The controlling process (e.g., the server) can enforce the existence of a few, or a single copy, as desired. This reduces waste of storage space, especially where multiple copies of a large attachment (e.g., an image or video file) would otherwise proliferate throughout a network. Email can also be sent more quickly as only a link to the attachment needs to be sent. A sender can update or delete an attachment if there was a mistake in attaching the wrong object. If a single version is enforced then users are always assured that they are reviewing and working with the correct version. Errors due to parallel team editing can be reduced or eliminated by appropriate control by the server of editing rights to the attachment. Copies of attachments can be secured by, for example, encrypting, or using other access right mechanisms. Secure transfer methods such as SSL can be used to protect the document while it is being transferred.

A preferred embodiment of the invention is implemented using web pages and web browsers in coordination with email processes and various applications. Hyper Text Markup Language (HTML), JavaScript and other standardized languages and protocols common to digital networks are employed. An attachment is associated with an email by having a hypertext link embedded in the email to a managing web page. The web page can reside on the server computer or elsewhere.

When a user clicks on the embedded link, a web page browser is launched to view the managing web page. Information that identifies the document is also sent via Hyper Text Transfer Protocol (HTTP) to the web page server. The managing web page, includes links for, e.g., opening the document read-only in the web browser, opening the document read-write in the native application that was used to prepare the attachment, opening a previous version of the document, checking out the document, etc.

Note that other approaches, rather than the web-based approach of the preferred embodiment, can be used to implement the features of the invention. For example, the server can execute a separate process, ActiveX or Simple Object Access Protocol (SOAP) controls can be employed, a plug-in to a browser can be used, etc. In general, features of the invention can be implemented by any suitable programming techniques. Functionality can be by any type of hardware, software or combination. Specific functions can reside in different locations and can be performed by one or more processing devices in isolation or in concert.

The invention allows for users to attach objects stored locally on a user's computer. In this case, the object is uploaded to the server at the time of sending the attached object. Another user-selectable option is to upload documents to the server at a prior time, and then attach the document(s) to an email message later on.

User Interface

A user uses a client email program to compose an email message. The user can attach an object to the email in a variety of ways such as by using an “Attach” button in the email interface, by clicking a File menu and selecting an Insert option, or by dragging and dropping the object onto the email message on a display screen. Still other ways to associate an object with email include right-clicking on the object's representation on the user's display screen, or using a File/Send To selection from an application program. In general, any manner of designating the attachment is acceptable.

An object can be designated as an “Intellitach” object, so that it is handled as an attachment according to the manner described herein, either prior to, during or after object creation. For example, a user can click a “Create Intellitach” button in a client interface referred to as the Xythos Client Intellitach interface. The Xythos Client can also monitor for object creation within application programs and prompt a user to specify that the object is to be an Intellitach object. If so, the Xythos Client uploads the object (or a copy of the object, as preferred by the user) to the server. Access control levels and security controls, such as issuing tickets or other authentication procedures, can be followed.

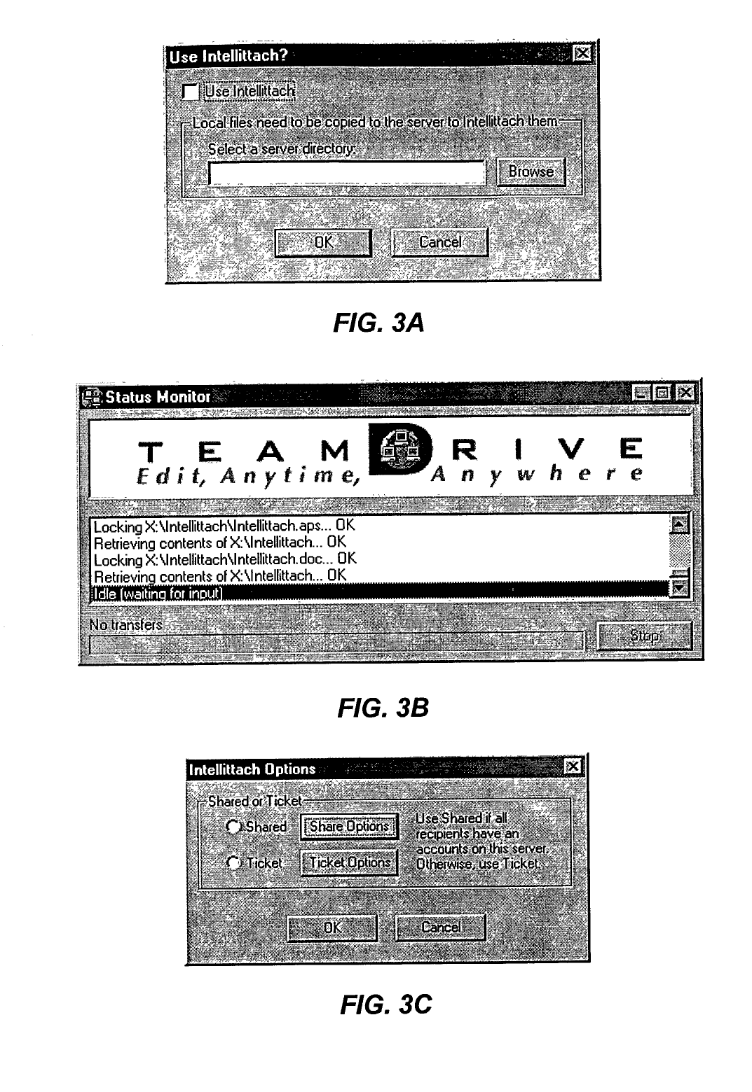

FIG. 3A shows a first dialogue box that appears when a user is prompted to designate a file as an Intellitach file.

In FIG. 3A, a user can designate the file as Intellitach, or work without the Intellitach features. If designated as an Intellitach file then the user can specify a server and path that will be used to store the master copy of the object (e.g., a document). After “OK” is pressed a status monitor is displayed.

FIG. 3B shows an example of the Status Monitor. The status monitor displays the progress while the document is being saved to the server. The status monitor can be minimized and deleted. Note that the level of detail of information provided by the monitor can vary among implementations.

Once the user's file has been uploaded, an options dialog appears as shown in FIG. 3C. With the options dialog a user can select whether the uploaded document is to be controlled with sharing options or tickets (or no control). A “ticket” is a special access name that provides access to the object without need for typing in additional passwords, because the user authentication is part of the access name. After security levels have been set, the user clicks “OK”. The Xythos Client then inserts a hyperlink into the email message that references a server page that provides options and controls for accessing the attachment. Alternatively, the hyperlink and other code and information can be provided to a standard “clipboard” or other repository and a user can manually “cut and paste” or otherwise copy the link and code into an email message. Other approaches are possible.

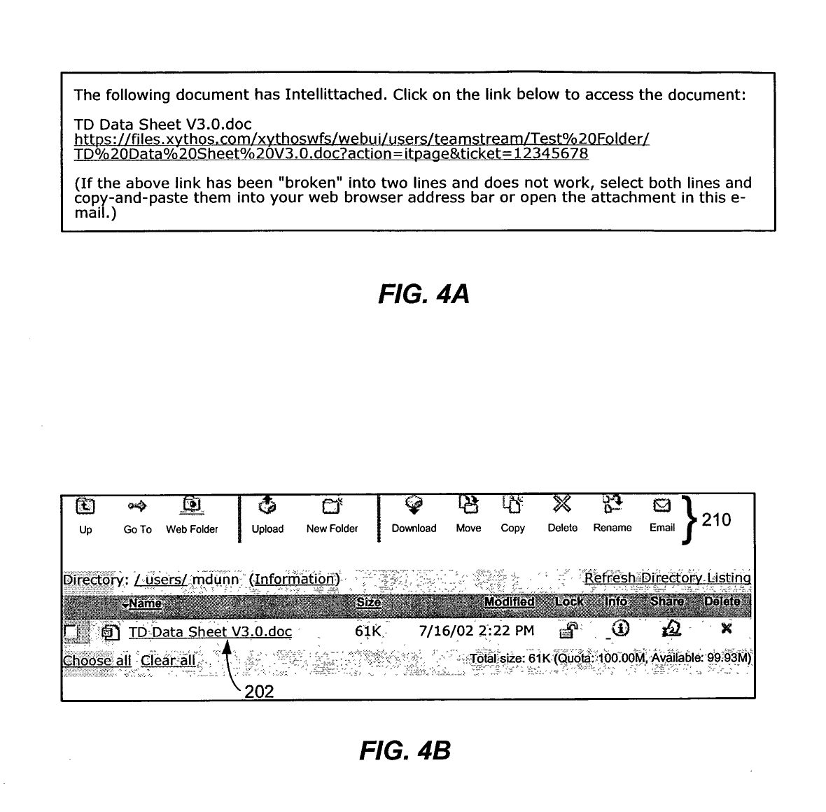

FIG. 4A shows the text and link that is inserted into an email to allow a recipient of the email to access the associated attachment. Note that other information can be provided. The text can include format codes such as HTML, XML, etc., and can include hidden data and functional code such as Javascript, etc. The text and link is provided both embedded into the text of the email message and/or as a small attachment. However, other ways of providing the text and link are possible. The sending user can edit and modify the text before sending. Multiple links can be provided if there are multiple attachments. The user or administrator can set defaults for the above sets of screens so that the user is only presented with selected screens.

When a recipient of the email clicks on the link, a controller web page is accessed and opened from the server. FIG. 4B shows an example of a controller web page along with exemplary features and functions.

In FIG. 4B, the attachment document's name is show at 202. Typical information about the document is shown. For example, the document's size and last-modified date and time are displayed. A recipient of the email attachment (i.e., the link) can obtain additional information by clicking in the provided areas for “Lock,” “Info,” and “Share”. Other capabilities can be added such as comments, discussions, etc. If the recipient has sufficient permission, the document can be deleted.

Additional document operations are provided by selecting the icons at 210 on a toolbar at the top of the access web page. These functions are self-explanatory and additional, or other, functions can be provided.

Rather than have the access web page open when a link is clicked, the document associated with the link can automatically be opened. That is, upon clicking an embedded Intellitach link in an email message the document associated with the link can be opened, directly, so that the document is displayed immediately.

Although the invention has been described with respect to specific embodiments, thereof, these embodiments are merely illustrative, and not restrictive of the invention. For example, although an email application has been discussed extensively, any type of application can be used. Further, different email systems can be adapted in different ways to provide aspects of the invention. The user interface, including attachment creation and designation, access web page functions, and other functions can be provided in any practicable manner. All features of the invention need not be present in all embodiments.

Note that any processor, other than a computer system, can be employed. For example, client functionality can be provided by a consumer electronic device such as a personal digital assistant, cellular telephone, pager, etc. In general, any type of processor, or processing device, can be used with the invention. A “system” is intended to mean any type of hardware, software or combination of both.

Thus, the scope of the invention is to be determined solely by the appended claims.

What is claimed is:

1. A method for transferring an email attachment from a first processing system to a second processing system via an intermediary system, the method comprising
accepting signals from a user input control coupled to the first processing system to create an email message;
accepting signals from a user input control coupled to the first processing system to designate an attachment to the email message;
transferring at least one copy of the email message to other computer systems;
storing a master copy of the attachment in the intermediary system; and
ensuring that each copy of the email message includes a link to the master copy of the attachment stored in the intermediary system.

2. The method of claim 1, further comprising
replacing the master copy of the attachment with an updated copy so that all links that previously referenced the master copy subsequently reference the updated copy and do not reference the master copy.

3. The method of claim 1, further comprising
maintaining multiple versions of the attachment in a version controlled system.

4. The method of claim 1, further comprising
designating access rights to the master copy.

5. The method of claim 1, further comprising
implementing security measures to restrict access to the master copy

6. The method of claim 1, wherein the attachment includes document information.

7. The method of claim 1, wherein the attachment includes image information.

8. The method of claim 1, wherein the attachment includes audio information.

9. The method of claim 1, wherein the attachment includes spreadsheet information.

10. The method of claim 1, wherein additional versions of the master copy are stored in the server computer.

11. The method of claim 10, wherein an email message is updated to link to one or more of the additional versions.

12. The method of claim 11, wherein an email message is updated to link to a most recent version.

13. A computer readable medium including one or more instructions executable by a processor for transferring an email attachment from a first processing system to a second processing system via an intermediary system, the computer readable medium comprising
one or more instructions for accepting signals from a user input control coupled to the first processing system to create an email message;
one or more instructions for accepting signals from a user input control coupled to the first processing system to designate an attachment to the email message;
one or more instructions for transferring at least one copy of the email message to other computer systems; and
one or more instructions for ensuring that each copy of the email message includes a link to a master copy of the attachment.

14. A method for transferring linked information from a first processing system to other processing systems, the method comprising
accepting signals from a user input control coupled to the first processing system to create a primary object;
accepting signals from a user input control coupled to the first processing system to designate an attachment object;
accepting signals from a user input control coupled to the first processing system to associate the attachment object with the primary object;
transferring at least one copy of the primary object to other computer systems; and
ensuring that each copy of the primary object includes a link to a single copy of the attachment object.

15. A method for creating linked information on a first processing system, the method comprising
accepting signals from a user input control coupled to the first processing system to create a primary object;
accepting signals from a user input control coupled to the first processing system to create an attachment object;
receiving a signal from a user input control to designate the attachment object as a linked object; and
in response to the step of receiving, embedding a pointer associated with the primary object in the primary object.
